(19) United States
(12) Patent Application Publication
(10) Pub. No.: US 2024/0387921 A1
(43) Pub. Date: Nov. 21, 2024

(54) CASE SIDE WALL OF BATTERY CASE

(71) Applicant: TOYOTA JIDOSHA KABUSHIKI KAISHA, Toyota-shi (JP)

(72) Inventors: Katsunori HIGASHIHARA, Toyota-shi (JP); Takahiro Fukuoka, Toyota-shi (JP); Haruhiko Yamamoto, Miyoshi-shi (JP); Hina Kato, Toyota-shi (JP)

(73) Assignee: TOYOTA JIDOSHA KABUSHIKI KAISHA, Toyota-shi (JP)

(21) Appl. No.: 18/607,688

(22) Filed: Mar. 18, 2024

(30) Foreign Application Priority Data
May 17, 2023 (JP) 2023-081439

(51) Int. Cl. H01M 50/242; B60K 1/04; B60L 50/64; H01M 50/204; H01M 50/224

(52) U.S. Cl. CPC H01M 50/242; B60L 50/64; H01M 50/204; H01M 50/224; B60K 1/04; B60K 2001/0438; H01M 2220/20

(57) ABSTRACT

The case side wall of the battery case has a tubular portion with a closed cross-section structure consisting of an upper wall, a lower wall, an inner wall, and an outer wall, an inner flange, and an outer flange. A first member made of a steel plate forms an inner flange, an inner wall, an upper wall, an outer wall upper portion, and an outer flange, and a second member made of a steel plate forms an outer flange, an outer wall lower portion, a lower wall, and two reinforcing walls. The reinforcing wall is located in the interior space of the tubular portion at the same height as and below the outer flange. A reinforcing wall is placed at a position facing the shock absorber, increasing the strength of this part, suppressing deformation of the case side wall in a side collision, and suppressing damage to the battery case.

### CROSS-REFERENCE TO RELATED APPLICATION

This application claims priority to Japanese Patent Application No. 2023-081439 filed on May 17, 2023, incorporated herein by reference in its entirety.

### BACKGROUND

### 1. Technical Field

The disclosure relates to a battery case that houses a battery installed in a vehicle, and more particularly relates to a structure of a case side wall.

### 2. Description of Related Art

In vehicles equipped with an electric motor as a driving prime mover, there are known vehicles equipped with a battery that supplies power to the electric motor. Japanese Unexamined Patent Application Publication No. 2022-42851 (JP 2022-42851 A) describes a battery case (battery case 100) in which a bathtub-shaped tray (120) is disposed on an inner side of a square window-sash-like frame (110), and a battery (battery 30) is housed in a recessed part of the tray (120). Also, paragraph 0087 of JP 2022-42851 A describes that the frame (110) is formed of a steel sheet roll-forming material. Note that the member names and signs in the parentheses above are those used in JP 2022-42851 A, and do not correspond to the member names and signs used in the description of the embodiment of the present application.

### SUMMARY

Battery cases are required to have sufficient strength to protect batteries housed therein in an event of a vehicle collision.

It is an object of the disclosure to ensure strength of a battery case made of a steel plate in an event of a vehicle collision.

A case side wall of a battery case of an in-vehicle battery according to the disclosure includes
a tubular portion with a closed cross-sectional structure, made up of an upper wall, an inner wall, an outer wall, and a lower wall,
an inner flange that is disposed along a longitudinal direction of the tubular portion and is erected on the inner wall,
an outer flange that is disposed along the longitudinal direction of the tubular portion and is erected at a position between an upper edge and a lower edge of the outer wall, and
at least one reinforcing wall that is disposed along the longitudinal direction of the tubular portion, in an internal space of the tubular portion at the same height or below the outer flange, with an inner side in a vehicle-width direction reaching the inner wall and an outer side in the vehicle-width direction reaching the outer wall.
   The inner flange is sealingly joined to a lower cover of the battery case, and the outer flange is joined to a load receiving member located on a side of the battery case, the load receiving member being a structure that receives a load in a side collision.
   The case side wall faces the load receiving member at a portion below the outer flange. Further, the case side wall
   includes a first member made of one steel plate that makes up the inner flange, a portion from an upper edge of the inner wall to an erect portion of the inner flange, the upper wall, a portion of the outer wall above the outer flange, and the outer flange, and
   also includes a second member made of one steel plate that makes up the reinforcing wall. A strength of the case side wall below the outer flange is higher than a strength of the case side wall above the outer flange, with respect to a side collision load.

Providing the reinforcing wall to increase the strength of the portion of the case side wall that faces the load receiving member enables deformation in a side collision to be suppressed.

In the case side wall,

the second member may make up a plurality of the reinforcing walls, and a portion of the second member may overlap with the first member to make up the outer flange together with the first member.
Also, the reinforcing wall situated at an uppermost position may be situated at the same height as the outer flange.

Providing multiple reinforcing walls enables the strength to be increased as compared to when there is only one reinforcing wall. Further, situating the reinforcing wall at the same height as that of the outer flange enables the strength in the vicinity of the input position of the load from the outer flange to be increased.

In the case side wall, a thickness of the second member may be greater than that of the first member. The strength of the reinforcing wall is increased, and the strength of the portion of the case side wall below the outer flange is increased.

In the case side wall,

the second member may make up a plurality of the reinforcing walls.
The case side wall may further include a third member made of one steel plate that makes up a portion of the outer wall below the outer flange, and that also partially overlaps with the first member to make up the outer flange together with the first member.

Providing multiple reinforcing walls enables the strength to be increased as compared to when there is only one reinforcing wall. Also, making a configuration from three members increases degree of freedom in shape and manufacturing method as compared to when making a configuration from two members.

In the case side wall, thicknesses of the second member and the third member may be greater than the thickness of the first member. The strength of the reinforcing wall is increased, and the strength of the portion of the case side wall below the outer flange is increased.

In a battery case made of steel plates, disposing a reinforcing wall in a part of a case side wall that faces a load receiving member increases strength of this part and suppresses deformation of the case side wall under a side collision load, whereby damage to the battery case can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an electrified vehicle equipped with a battery;

FIG. 2 is a diagram showing a schematic configuration of the battery pack, and is a diagram showing the inside with the upper cover removed;

FIG. 3 is a cross-sectional view of the case side wall and its surrounding structure;

FIG. 4 is a diagram showing how the first member and the second member forming the case side wall are joined;

FIG. 5 is a diagram showing another example of the structure of the case side wall;

FIG. 6 is a diagram showing still another configuration example of the case side wall;

FIG. 7 is a diagram showing still another configuration example of the case side wall;

FIG. 8 is a diagram showing still another configuration example of the case side wall; and

FIG. 9 is a diagram showing still another example of the structure of the case side wall.

### DETAILED DESCRIPTION OF EMBODIMENTS

Embodiments of the present disclosure will be described below with reference to the drawings. In the following description, unless otherwise specified, words expressing relative positions and directions, such as front, rear, left, right, top and bottom, refer to relative positions and directions with respect to the vehicle. In addition, in the left-right direction (width direction) of the vehicle, the side closer to the center line extending in the longitudinal direction of the vehicle is referred to as the inner side in the vehicle width direction, and the side farther away from the center line is referred to as the outer side in the vehicle width direction. In each figure, arrow FR points forward, arrow UP points upward, arrow LH points leftward, and arrow OUT points outward in the vehicle width direction.

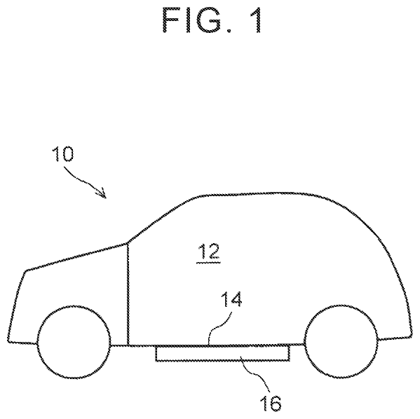

FIG. 1 is a diagram showing a schematic configuration of an electrified vehicle 10. The electrified vehicle 10 may be a battery electric vehicle having only an electric motor as a prime mover for driving the vehicle, or may be a hybrid electric vehicle having an electric motor and a motor as prime movers for driving the vehicle. The electrified vehicle 10 is equipped with a battery pack 16 below the floor 14 of the passenger compartment 12, which includes a battery that supplies power to the vehicle drive electric motor.

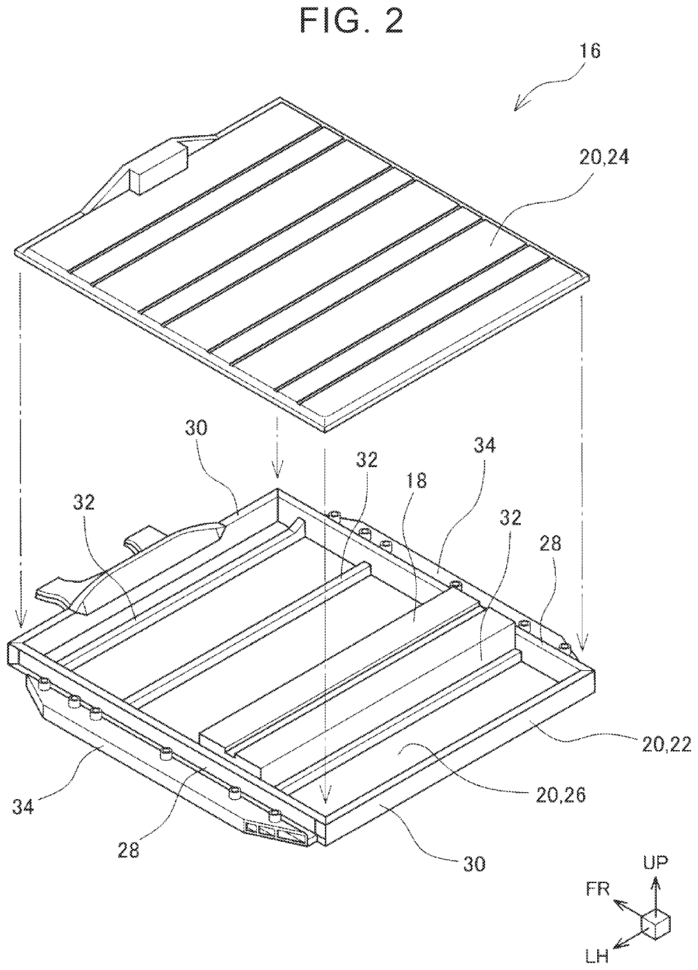

FIG. 2 is a perspective view showing a schematic configuration of the battery pack 16 with the inside visible. The battery pack 16 includes a battery stack 18 in which battery cells are stacked, and a battery case 20 that houses the battery stack 18. In FIG. 2, only one battery stack 18 is shown. The battery case 20 includes a rectangular frame 22, and an upper cover 24 and a lower cover 26 that are arranged to sandwich the frame 22 from above and below. The upper cover 24 and the lower cover 26 are sealingly coupled to the frame 22 at their peripheral edges, and the battery case 20 is sealed. The frame 22, upper cover 24 and lower cover 26 define a space in which battery stack 18 is housed.

The frame 22 has left and right case side walls 28 extending in the front-rear direction, and front and rear case end walls 30 extending in the left-right direction. The front ends of the left and right case side walls 28 and both ends of the front case end wall 30 are combined, and the rear ends of the left and right case side walls 28 and both ends of the rear case end wall 30 are combined to form a rectangular frame shape. Ru. An inner cross member 32 is disposed between the left and right case side walls 28 and extends in the left-right direction and has both ends coupled to the case side walls 28. The inner cross member 32 is also coupled to lower cover 26. In the illustrated battery pack 16, there are four inner cross members 32. The battery stacks 18 are arranged between adjacent inner cross members 32 and between the rearmost inner cross member 32 and the rear case end wall 30, respectively. Therefore, the battery case 20 accommodates four battery stacks 18.

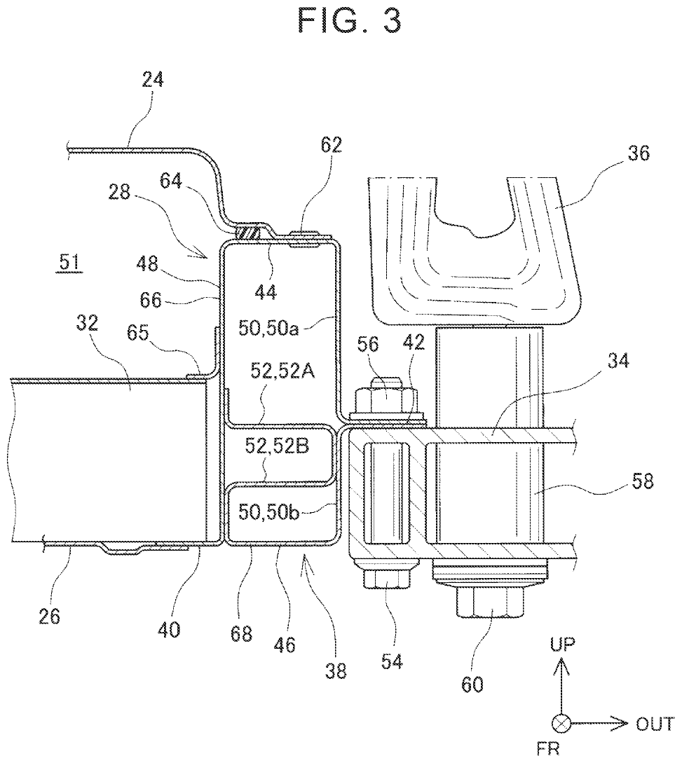

A shock absorber 34 is arranged outside the frame 22 in the vehicle width direction. The shock absorber 34 is coupled to the case side wall 28 by fastening parts such as bolts and nuts. The shock absorber 34 is a load receiving member that receives a collision load from the side when the electrified vehicle 10 has a side collision. Further, the shock absorber 34 deforms itself due to the load received, absorbs the collision energy, and reduces the load applied to the battery pack 16. The shock absorber 34 is arranged to extend along the front-rear direction, and includes an outer shell portion having a closed section whose cross section orthogonal to the front-rear direction is approximately square, and at least one partition wall that partitions an inner space of the outer shell in the left-right direction. have. The shock absorber 34 may be formed by extrusion molding aluminum. The battery pack 16 is suspended and supported by the floor 14 via a shock absorber 34. The shock absorber 34 is fixed by bolts to lockers 36 (see FIG. 3) located on the left and right side edges of the floor 14, and the battery pack 16 is fixed under the floor of the electrified vehicle 10.

FIG. 3 is a diagram showing a cross section of the case side wall 28 of the battery pack 16 and its surrounding structure perpendicular to the front-rear direction. The case side wall 28 includes a tubular portion 38 having a substantially rectangular closed cross-sectional structure, an inner flange 40 extending inward from the tubular portion 38 in the vehicle width direction, and an outer flange 42 extending outward from the tubular portion 38 in the vehicle width direction. and has. The outer flange 42 is formed by stacking two steel plate members as described later. The tubular portion 38 has an upper wall 44 corresponding to the upper side of the rectangular cross-sectional shape, a lower wall 46 corresponding to the lower side, an inner wall 48 corresponding to the inner side in the vehicle width direction, and an outer side in the vehicle width direction. It has a corresponding outer wall 50. The inner wall 48 directly faces the space accommodating the battery stack 18, that is, the battery accommodating space 51 of the battery case 20.

A reinforcing wall 52 is arranged in the internal space surrounded by the tubular portion 38. The reinforcing wall 52 extends along the entire length of the case side wall 28 in the front-rear direction. The reinforcing wall 52 may be arranged in a plane perpendicular to the vertical direction. The inner edge of the reinforcing wall 52 in the vehicle width direction reaches the inner wall 48, and the outer edge in the vehicle width direction reaches the outer wall 50. This battery case 20 includes two reinforcing walls 52. The upper reinforcing wall 52A is arranged at the same height position as the outer flange 42, which is formed by stacking two steel plates, that is, at the same position in the vertical direction. The lower reinforcing wall 52B is arranged approximately at the center between the upper reinforcing wall 52A and the lower wall 46. One reinforcing wall 52 may be arranged, or three or more reinforcing walls 52 may be arranged. The uppermost reinforcing wall 52 is located at the same height as the outer flange 42. That is, no reinforcing wall is arranged at a position higher than the outer flange 42.

The inner flange 40 is erected on the inner wall 48 and extends in the vehicle longitudinal direction over the entire length of the case side wall 28. Inner flange 40 may be located at the lower edge of tubular portion 38. The outer flange 42 is erected on the outer wall 50 and extends along the entire length of the case side wall 28 in the vehicle longitudinal direction. The outer flange 42 is located between the upper and lower edges of the outer wall 50.

The outer flange 42 is fastened to the upper surface of the shock absorber 34 with bolts 54 and nuts 56. A portion of the case side wall 28 below the outer flange 42 faces the shock absorber 34. A cylindrical collar 58 is further fixed to the shock absorber 34 by a method such as welding, and the shock absorber 34 is attached to the vehicle body by a bolt 60 extending through the collar 58 and a nut (not shown). It is fixed to the lower surface of the locker 36, which is one of the frame members. Thereby, the battery pack 16 is suspended and supported by the vehicle body.

The lower cover 26 is joined to the inner flange 40 by a method such as welding or adhesive, and the gap therebetween is sealed. The upper cover 24 is connected to the case side wall 28, in particular to the upper wall 44 of the tubular portion 38. Upper cover 24 is coupled to upper wall 44 by rivets 62. Further, the space between the upper cover 24 and the upper wall 44 is sealed with a sealing member 64 such as an adhesive at a position inward in the vehicle width direction from a position where the upper cover 24 is joined by the rivet 62. The sealing member 64 is arranged over the entire length of the case side wall 28.

An inner cross member 32 is coupled onto the lower cover 26, and the inner cross member 32 is coupled at its end to the inner wall 48 of the case side wall 28 via a coupling bracket 65. The inner cross member 32 and the coupling bracket 65, and the coupling bracket 65 and the inner wall 48 are coupled by welding, particularly arc welding. The inner cross member 32 is at least partially located below outer flange 42. Further, in the vertical direction, two reinforcing walls 52A and 52B exist in the range where the inner cross member 32 exists.

The case side wall 28 is formed from two members, a first member 66 and a second member 68, each made of a roll-formed steel plate. The first member 66 and the second member 68 extend over the entire case side wall 28 in the front-rear direction. The second member 68 may be divided into a plurality of parts in the front-rear direction. The first member 66 forms the inner flange 40, the inner wall 48, the upper wall 44, a portion of the outer wall 50 above the position where the outer flange 42 is erected, and the outer flange 42. The first member 66 is formed into the illustrated shape by bending a single steel plate by rolling. The second member 68 forms the outer flange 42, a portion of the outer wall 50 below the position where the outer flange 42 is erected, the lower wall 46, and the two reinforcing walls 52A and 52B. The second member 68 is also formed into the illustrated shape by bending a single steel plate by roll processing. Hereinafter, the portion of the outer wall 50 above the outer flange 42 will be referred to as the “outer wall upper portion 50a” and the lower portion will be referred to as the “outer wall lower portion 50b.”

The second member 68 is partially overlapped and joined to the first member 66, and this overlapped portion forms the outer flange 42 together with the first member 66. In addition, the second member 68 is connected to the inner wall 48 at a portion between the portion forming the lower wall 46 and the portion forming the lower reinforcing wall 52B, and at a portion closer to the edge than the portion forming the upper reinforcing wall 52A. It is overlapped and joined with a part of. Further, the second member 68 is overlapped and joined to a portion forming the outer wall lower portion 50b of itself at a portion between the portion forming the upper reinforcing wall 52A and the portion forming the lower reinforcing wall 52B.

By providing the reinforcing wall 52 on the case side wall 28 at the same height as the outer flange 42 and at a position below the outer flange 42, the strength of the portion of the case side wall 28 facing the shock absorber 34 is increased. As a result, the portion of the case side wall 28 below the outer flange 42 deforms less than the portion above when receiving the same load from the side. When a load due to a side collision is input to the case side wall 28 from the shock absorber 34, the collision load is received by a portion with high strength, and deformation of the case side wall 28 is suppressed. Further, since the reinforcing wall 52A is located at the same height as the outer flange 42, the vicinity of the input position of the load from the outer flange 42 is reinforced. This helps increase the strength of the case side wall 28 against the side collision load input from the outer flange 42. Further, the second member 68 forming the case side wall 28 may be thicker than the first member 66. Thereby, the strength of the portion of the case side wall 28 facing the shock absorber 34 can be further increased. Further, since the strength of the portion below the outer flange 42 is high, the load received by the portion of the case side wall 28 below the outer flange 42 is transferred to the case end wall 30 and the inner cross member 32 which are far from the load input position in the front-rear direction. It is transmitted to Therefore, the collision load is distributed and transmitted to the front and rear case end walls 30 and the four inner cross members 32. This prevents a large load from being applied locally to the battery case 20.

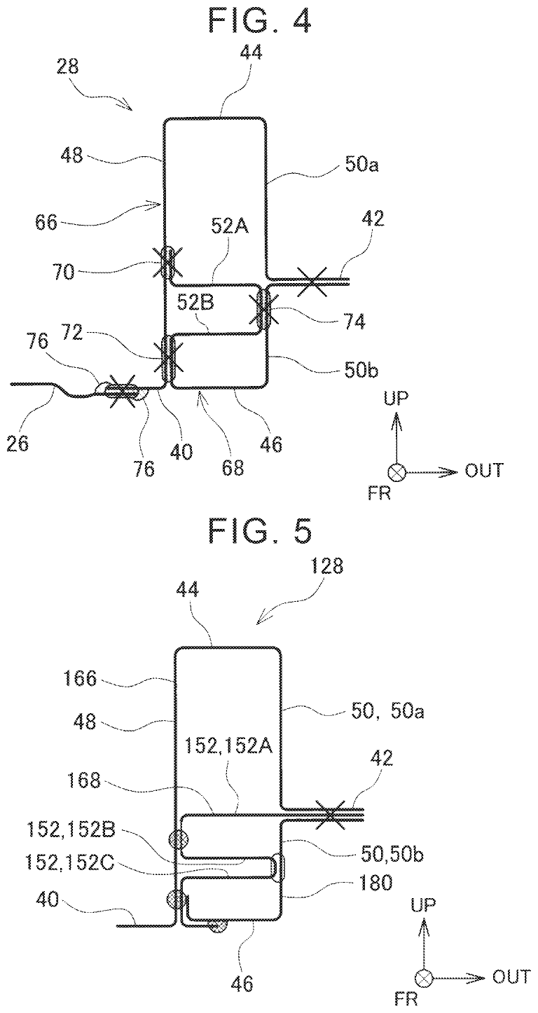

FIG. 4 is a schematic diagram illustrating an example of how the first member 66 and second member 68 forming the case side wall 28 are joined. The x marks in the figure indicate the spot welding positions, the shaded oval portions indicate the portions to be joined with adhesive, and the hatched semicircular portions indicate the precure seal portions.

The first member 66 and the second member 68 are joined by spot welding at a portion forming the outer flange 42. The joint portions 70 and 72 between the inner wall 48 and the second member 68 are joined using an adhesive and spot welding. Further, the second member 68 is overlapped with itself at the outer wall lower portion 50b and joined using an adhesive and spot welding (joint portion 74). Furthermore, the inner flange 40 of the first member 66 and the lower cover 26 are joined by adhesive and spot welding. The adhesive is applied over the entire length of the inner flange 40. In addition, a precure sealer 76 is applied along the entire length of the inner flange 40 along the edge of the inner flange 40 and along the edge of the lower cover 26, and is cured in a later heating process to seal the inner flange 40. and the lower cover 26 are sealed.

FIGS. 5 to 9 are diagrams schematically showing case side walls 128, 228, 328, 428, 528 in other embodiments. In each figure, the x mark indicates the position of spot welding, and the shaded oval part indicates the part to be joined with adhesive. Further, a semicircular portion with double hatching indicates a portion to be arc welded, and a circular portion with double hatching indicates a portion to be seam welded. The relationship between each case side wall and the surrounding structure is similar to that of the case side wall 28 described above.

The case side wall 128 shown in FIG. 5 is formed from three members. The three members, the first member 166, the second member 168, and the third member 180, are each formed by roll forming a single steel plate. The first member 166 is the same as the first member 66 of the case side wall 28 described above. The second member 168 forms three reinforcing walls 152. The three reinforcing walls 152 may be arranged in a plane perpendicular to the vertical direction. When distinguishing the three reinforcing walls 152, they are written as reinforcing wall 152A, reinforcing wall 152B, and reinforcing wall 152C from the top. In the second member 168, the reinforcing wall 152A is continuous with the portion forming the outer flange 42, and these form one plane. The third member 180 forms the outer wall lower portion 50b and the lower wall 46.

The second member 168 is joined to the third member 180 at the lower wall 46 by arc welding. Further, by overlapping a portion of the second member 168 and a portion of the third member 180 with a portion forming the outer flange 42 of the first member 166, a portion of the second member 168 and a portion of the third member 180 overlap. The portion together with the first member 166 forms the outer flange 42. The second member 168 is joined to a portion of the first member 166 forming the inner wall 48 by seam welding between the reinforcing wall 152A and the reinforcing wall 152B, and between the reinforcing wall 152C and the lower wall 46. Further, the second member 168 is joined to a portion of the third member 180 forming the outer wall lower portion 50b with an adhesive between the reinforcing wall 152B and the reinforcing wall 152C.

By providing the reinforcing wall 152 at the same height as the outer flange 42 of the case side wall 128 and at a position below the outer flange 42, the strength of the portion of the case side wall 128 facing the shock absorber 34 is increased. When a load due to a side collision is input to the case side wall 128 from the shock absorber 34, the collision load is received by a portion with high strength, and deformation of the case side wall 128 is suppressed. The uppermost reinforcing wall 152A of the second member 168 is continuous with the portion forming the outer flange 42 and forms the same plane. The load input from the outer flange 42 is transmitted via a member that forms the same plane as the outer flange 42, and the load can be efficiently transmitted to the reinforcing wall 152A. As a result, the vicinity of the load input position from the outer flange 42 is reinforced. Further, by providing three reinforcing walls 152, the strength of the case side wall 128 can be made higher than when there are two reinforcing walls. The second member 168 and the third member 180 may be thicker than the first member 166. Thereby, the strength of the portion of the case side wall 128 facing the shock absorber 34 can be further increased.

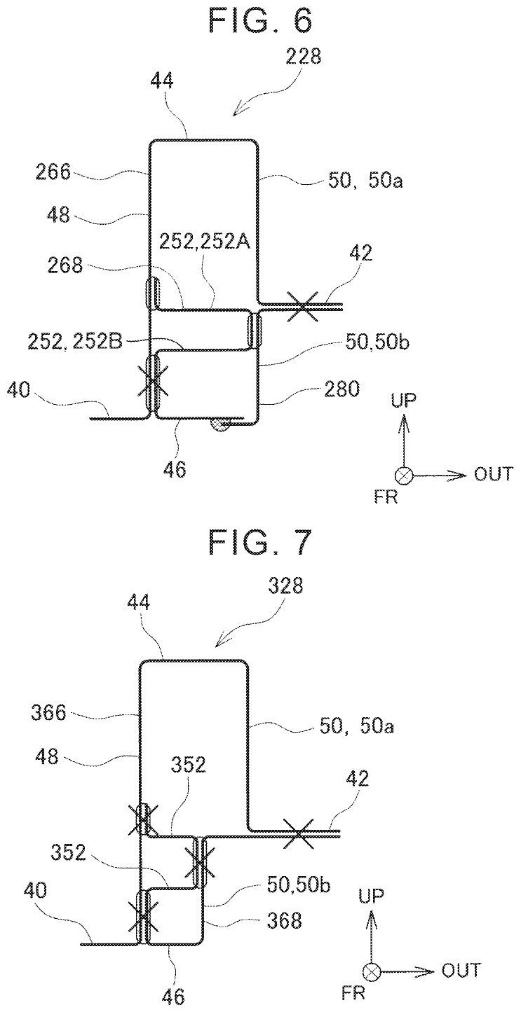

The case side wall 228 shown in FIG. 6 is formed from three members. The three members, the first member 266, the second member 268, and the third member 280, are each formed by roll forming a single steel plate. The first member 266 is the same as the first member 66 of the case side wall 28 described above. The second member 268 forms two reinforcing walls 252. The two reinforcing walls 252 may be arranged in a plane perpendicular to the vertical direction. When distinguishing between the two reinforcing walls 252, the one located above is referred to as a reinforcing wall 252A, and the one located below is referred to as a reinforcing wall 252B. The reinforcing wall 252A is located at the same height as the outer flange 42. The second member 268 further forms the lower wall 46. The third member 280 forms the outer wall lower portion 50b and the outer flange 42. The outer flange 42 is formed by overlapping a portion of the first member 266 and a portion of the third member 280.

The third member 280 is joined to the second member 268 at the lower wall 46 by arc welding. The second member 268 is joined to the portion of the first member 266 that forms the inner wall 48 by adhesive on the edge side of the reinforcing wall 252A. Further, the second member 268 is joined to a portion of the first member 266 that forms the inner wall 48 between the reinforcing wall 252B and the lower wall 46 by adhesive and spot welding. Further, the second member 268 is joined to a portion of the third member 280 forming the outer wall lower portion 50b with an adhesive between the reinforcing wall 252A and the reinforcing wall 252B.

By providing the reinforcing wall 252 at the same height as the outer flange 42 of the case side wall 228 and at a position below the outer flange 42, the strength of the portion of the case side wall 228 facing the shock absorber 34 is increased. When a load due to a side collision is input to the case side wall 228 from the shock absorber 34, the collision load is received by a portion with high strength, and deformation of the case side wall 228 is suppressed. The uppermost reinforcing wall 252A of the second member 268 is located at the same height as the portion forming the outer flange 42. Thereby, the vicinity of the input position of the load from the outer flange 42 is reinforced. The second member 268 and the third member 280 may be thicker than the first member 266. Thereby, the strength of the portion of the case side wall 228 facing the shock absorber 34 can be further increased.

The case side wall 328 shown in FIG. 7 is the case side wall 28 shown in FIG. 4 with different dimensions in the vehicle width direction above and below the outer flange 42. The first member 366 and the second member 368 are both formed by roll forming a single steel plate. The first member 366 is the same as the first member 66 of the case side wall 28 described above. Regarding the second member 368, a portion forming the outer flange 42 extends inward in the vehicle width direction with respect to the second member 68 described above. The length of the portion of the second member 368 that forms the reinforcing wall 352 and the lower wall 46 is shortened by the length that the portion that forms the outer flange 42 is extended. The case side wall 328 is advantageous when a distance from the shock absorber 34 is desired or when the shock absorber 34 having large dimensions in the vehicle width direction is used.

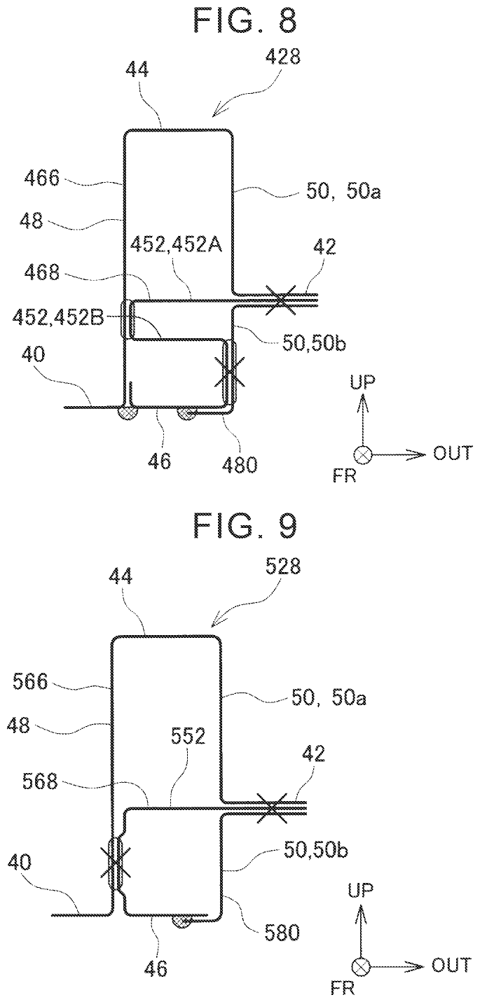

The case side wall 428 shown in FIG. 8 is formed from three members. The three members, the first member 466, the second member 468, and the third member 480, are each formed by roll forming a single steel plate. The first member 466 is the same as the first member 66 of the case side wall 28 described above. The second member 468 forms part of the two reinforcing walls 452, the lower wall 46, and the outer wall lower portion 50b. The two reinforcing walls 452 may be arranged in a plane perpendicular to the vertical direction. When distinguishing between the two reinforcing walls 452, the one located above is called a reinforcing wall 452A, and the one located below is called a reinforcing wall 452B. In the second member 468, the reinforcing wall 452A is continuous with the portion forming the outer flange 42, and these form one plane. The third member 480 forms the outer wall lower portion 50b.

The second member 468 is joined to the first member 466 by arc welding at the lower edge of the portion of the first member 466 that forms the inner wall 48. Further, the second member 468 is bonded to a portion of the first member 466 that forms the inner wall 48 with an adhesive at a portion between the two reinforcing walls 452A and 452B. The third member 480 is joined to the second member 468 by arc welding at the lower wall 46, and is joined to the second member 468 by adhesive and spot welding at the outer wall lower portion 50b. Additionally, a portion of the second member 468 and a portion of the third member 480 overlap with the portion of the first member 466 that forms the outer flange 42 to form the outer flange 42 with the first member 466.

By providing the reinforcing wall 452 at the same height as the outer flange 42 of the case side wall 428 and at a position below the outer flange 42, the strength of the portion of the case side wall 428 facing the shock absorber 34 is increased. When a load due to a side collision is input to the case side wall 428 from the shock absorber 34, the collision load is received by a portion with high strength, and deformation of the case side wall 428 is suppressed. The upper reinforcing wall 452A of the second member 468 is continuous with the portion forming the outer flange 42 and forms the same plane. The load input from the outer flange 42 is transmitted via a member that forms the same plane as the outer flange 42, and the load can be efficiently transmitted to the reinforcing wall 452A. As a result, the vicinity of the load input position from the outer flange 42 is reinforced. The second member 468 and the third member 480 may be thicker than the first member 466. Thereby, the strength of the portion of the case side wall 428 facing the shock absorber 34 can be further increased.

The case side wall 528 shown in FIG. 9 is formed from three members. The three members, the first member 566, the second member 568, and the third member 580, are each formed by roll forming a single steel plate. The first member 566 is the same as the first member 66 of the case side wall 28 described above. The second member 568 forms one reinforcing wall 552 and the lower wall 46. The reinforcing wall 552 may be arranged in a plane perpendicular to the vertical direction. In the second member 568, the reinforcing wall 552 is continuous with the portion forming the outer flange 42, so that they form one plane. The third member 580 forms the outer wall lower portion 50b.

The second member 568 is located along the inner wall 48 at a portion between the reinforcing wall 552 and the lower wall 46, and is joined to the first member 566 at this portion by adhesive and spot welding. The third member 580 is joined to the second member 568 at the lower wall 46 by arc welding. Further, a portion of second member 568 and a portion of third member 580 overlap with first member 566 to form outer flange 42. The second member 568 and the third member 580 are thicker than the first member 566. Furthermore, the thickness of the second member 568 may be greater than the thickness of the third member 580.

By making the second member 568 thicker than the first member 566 and by providing the reinforcing wall 552 at the same height as the outer flange 42 of the case side wall 528, the strength of the portion facing the shock absorber 34 of the case side wall 528 is increased. When a load due to a side collision is input to the case side wall 528 from the shock absorber 34, the collision load is received by a portion with high strength, and deformation of the case side wall 528 is suppressed. The reinforcing wall 552 of the second member 568 is continuous with the portion forming the outer flange 42 and forms the same plane. The load input from the outer flange 42 is transmitted via a member that forms the same plane as the outer flange 42, and the load can be efficiently transmitted to the reinforcing wall 552. As a result, the vicinity of the load input position from the outer flange 42 is reinforced. This helps increase the strength of the case side wall 528 against side impact loads input from the outer flange 42.

When the outer flange 42 is formed by overlapping two steel plate members, the member forming the outer wall upper portion 50a and the member forming the outer wall lower portion 50b are overlapped. When the outer flange 42 is formed by overlapping three steel plate members, in addition to the member forming the outer wall upper portion 50a and the member forming the outer wall lower portion 50b, a member forming the reinforcing wall located at the same height as the outer flange 42 is overlapped.

What is claimed is:

1. A case side wall of a battery case of an in-vehicle battery, the case side wall comprising:
a tubular portion with a closed cross-sectional structure, made up of an upper wall, an inner wall, an outer wall, and a lower wall;
an inner flange that is disposed along a longitudinal direction of the tubular portion and is erected on the inner wall, and that is sealingly joined to a lower cover of the battery case;
an outer flange that is disposed along the longitudinal direction of the tubular portion and is erected at a position between an upper edge and a lower edge of the outer wall, and that is joined to a load receiving member located on a side of the battery case, the load receiving member being a structure that receives a load in a side collision; and
at least one reinforcing wall that is disposed along the longitudinal direction of the tubular portion, in an internal space of the tubular portion at the same height or below the outer flange, with an inner side in a vehicle-width direction reaching the inner wall and an outer side in the vehicle-width direction reaching the outer wall, wherein:
the case side wall faces the load receiving member at a portion below the outer flange;
the case side wall includes
a first member made of one steel plate that makes up an inner flange, a portion from an upper edge of the inner wall to an erect portion of the inner flange, the upper wall, a portion of the outer wall above the outer flange, and the outer flange, and
a second member made of one steel plate that makes up the reinforcing wall; and
a strength of the case side wall below the outer flange is higher than a strength of the case side wall above the outer flange, with respect to a side collision load.

2. The case side wall according to claim 1, wherein:
the second member makes up a plurality of the reinforcing walls, and a portion of the second member overlaps with the first member to make up the outer flange together with the first member; and
the reinforcing wall situated at an uppermost position is situated at the same height as the outer flange.

3. The case side wall according to claim 1, wherein a thickness of the second member is greater than that of the first member.

4. The case side wall according to claim 1, wherein:
the second member makes up a plurality of the reinforcing walls; and
the case side wall further includes a third member made of one steel plate that makes up a portion of the outer wall below the outer flange, and that also partially overlaps with the first member to make up the outer flange together with the first member.

5. The case side wall according to claim 4, wherein thicknesses of the second member and the third member are greater than the thickness of the first member.
